(19) United States
(12) Patent Application Publication
(10) Pub. No.: US 2005/0162518 A1
(43) Pub. Date: Jul. 28, 2005

(54) Display of the thumbnails of a photographic support on a terminal

(76) Inventors: Olivier A. Furon, Paris (FR); Jean-Marie Vau, Paris (FR); Santie V. Adelbert, Vincennes (FR)

Correspondence Address: PATENT LEGAL STAFF;EASTMAN KODAK COMPANY, 343 STATE STREET, ROCHESTER, NY, 14650-2201, US

(21) Appl. No.: 10/510,487

(22) PCT Filed: May 18, 2002
(86) PCT No.: PCT/EP02/05510

(51) Int. Cl. H04N 5/225

(52) U.S. Cl. 348/207.1

(57) ABSTRACT

The present invention is in the technical field of imaging. It relates to an application used in the photographic field. The invention relates more especially to a process applied in the field of hybrid photography, i.e. based on analog and digital image data. The invention process enables the display of images on a screen a terminal, from an identifier of an analog photographic support representing the images. The invention process operates the instructions of a program enabling a user of the terminal to display virtually in real time one or more digital images corresponding to the thumbnails of the photographic support.

The present invention is in the technical field of imaging. It relates to an application used in the photographic field, more especially in the field of hybrid photography, i.e. based on analog and digital image data.

In the photographic field, the communication of images has to be done rapidly and easily, taking into account especially the increasing use of digital devices that enable the display of images, but are not necessarily digital cameras as such. These digital devices, cameras or not, are terminals equipped with a display screen, as for example portable terminals. Today, portable terminals connect easily to Internet type networks in order to use messaging systems, for example of the PMS (Picture Messaging Service) or MMS (Multimedia Messaging Service) type. These connections let a user placed in any location to receive and display, for example on a portable terminal, digital images practically in real time. In parallel with the use of these digital devices, images, for example photographs, can be recorded and then reproduced after their development on silver-based photographic supports. These silver-based image supports for example comprise color photographic paper. It is interesting for the user, based on data from a silver-based image support, to be able to display these images rapidly on the screen of their portable terminal. This is with the double goal of viewing them on the one hand, and on the other hand being able to transmit them to another user of a portable terminal, after having viewed them.

The present invention relates to a process having the goal of interactively implementing an easy and rapid application letting the user of a terminal, equipped with a display screen, to view previously developed images printed on an analogical photographic support, for example of photographic film or paper type.

The invention process, enabling a digital image to be displayed on a terminal equipped with a keyboard and a display screen, is characterized by the following steps:
a) compose, from the terminal's keyboard, an electronic message including at least one identifier of a photographic support comprising thumbnails;

b) send, from the terminal, the electronic message composed in step a) to a messaging server identified by a unique telephone number,
c) automatically transmit said electronic message to a processing server;
d) automatically process, from the processing server, the electronic message sent, in order to select a set of digital images corresponding to the thumbnails of the identified photographic support and included in the electronic message;
e) automatically transmit to the terminal a notification of the availability of the set of selected digital images;
f) automatically display on the screen of the terminal the notification of the availability of the selected digital images;
g) validate, from the terminal, a display request for the available digital images;
h) automatically transmit the available digital images to the terminal;
i) automatically display said digital images on the screen of the terminal.

Other characteristics will appear on reading the following description, with reference to the drawings of the various figures.

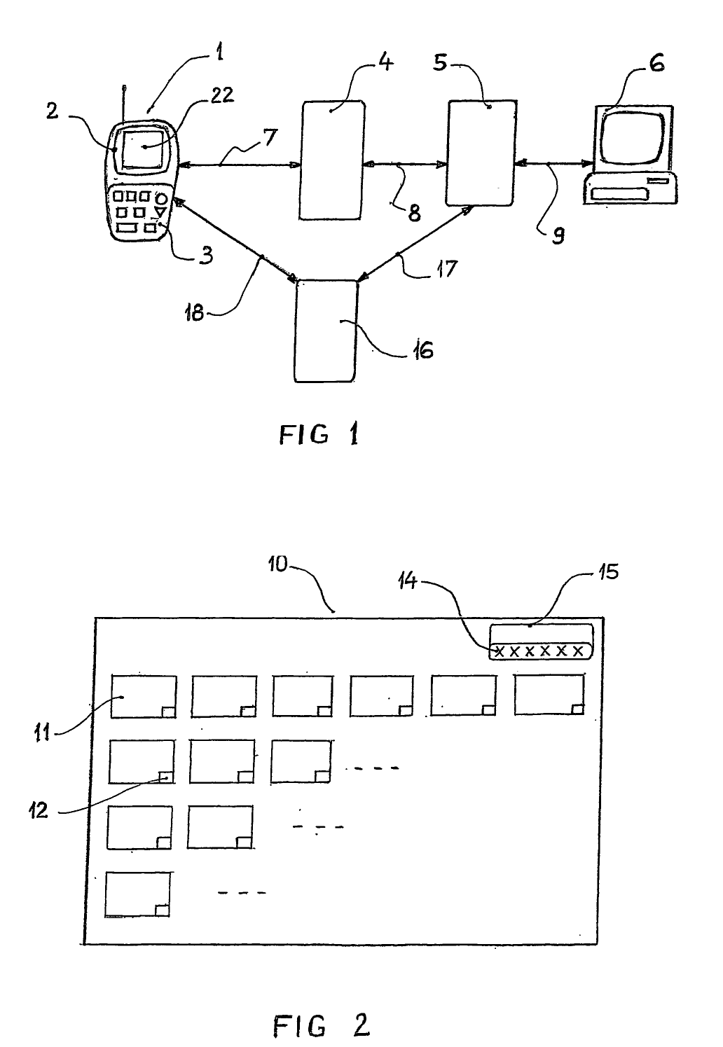

FIG. 1 represents diagrammatically the hardware environment for implementing the invention.

FIG. 2 represents diagrammatically an example of photographic support.

The following description is a detailed description of the main embodiments of the invention, with reference to the drawings in which the same numerical references identify the same elements in each of the different figures.

The present invention is implemented in a hardware environment represented diagrammatically in FIG. 1. A terminal 1, preferably portable, is equipped with a keyboard 3 and a display screen 2. This terminal is for example a cell phone. An image server 6 communicates by link 9 with a host server 5 for communication with a network for example Internet. The host server 5 communicates, by link 8, with a gateway 4, and by link 17, with a messaging server 16. The server 16 is an electronic messaging server, for example of SMS (Short Message Service) or MMS (Multimedia Message Service) type; the server 16 can also be a voice server. The gateway 4 is for communicating with the terminal 1 by a link 7. The gateway 4 is WAP type (Wireless Application Protocol), i.e. the link 7 between said gateway 4 and the terminal 1 is a wireless link. Communication between the terminal 1 and the gateway 4, as well as communication between the terminal 1 and the server 16, by a wireless link 18, are operated for example via a GSM (Global System for Mobile), GPRS (General Packet Radio System), or UMTS (Universal Mobile Telecom System) network. The image server 6 contains for example an image database. This image database enables the reception and storage of digital images from for example a photographic laboratory. The laboratory has for example processed, at the customer's request, a work order on photographic paper by developing one or more silver-based film strips supplied by the customer. The film strip(s) contain latent images previously recorded originally by the customer using suitable equipment: motion picture or still camera. As part of the photographic work order, the laboratory processes the silver-based images recorded originally, by developing them for example on silver-based photographic support(s), and then digitizing said original images, to transmit them into the image database of the server 6.

According to FIG. 2, the customer also has a photographic support 10 of said images. The photographic support 10, represented according to FIG. 2, is for example a support comprising photographic paper. In this case, the support 10 is called photographic index. The customer requests this photographic index 10 from the laboratory when they issue the photographic work order. The photographic index 10 is given to the customer when they collect their photographic work. The photographic index 10 comprises a plurality of thumbnails 11 (small images). The thumbnails 11 assembled on the photographic index 10 represent all the images recorded originally by the customer, and correspond to the order processed by the laboratory. If the number of recorded images is large, there are several photographic indexes 10 of thumbnails 11. The photographic index 10 contains for example 26 thumbnails 11. These thumbnails 11 are for example the result of a set of digital or silver halide images previously recorded. Each thumbnail 11 is assigned for example an alphanumeric identifier 12. This identifier 12 generally corresponds to the recording chronology of the images. If there are 26 thumbnails 11 on the photographic index 10, the first thumbnail 11 located at the top left of the photographic index 10 is for example assigned the identifier “0A”, and the last thumbnail 11 located at the bottom of the photographic index is for example assigned the identifier “25”. The photographic index 10 also comprises a zone 15, for example located at the top right of said index 10. The zone 15 is reserved for the traceability of the index 10. This zone 15 contains for example the execution date of the photographic work and a specific zone 14 that represents part of the traceability zone 15. The zone 14 contains the identifier of the photographic index 10. This identifier 14 is unique and specific to the index; it is encoded in digital (identification number) or alphanumeric form. The identifier of the photographic index is for example “667746”.

In other embodiments of the invention, not shown on drawings, a first variant of photographic support consists of placing for example the zone 14 containing the identifier of a photographic film strip comprising recorded latent images, on said film strip. In this case, the latent images recorded on the film strip correspond to the thumbnails 11. A second variant consists of mentioning for example the identifier 14 on an other material support, distinct from the photographic index or distinct from the photographic film strip. This distinct material support is for example a loyalty card, delivered by the photographic laboratory providing the processing of the images. This second variant is used for example when the customer does not wish to have photographic indexy The invention process operates the instructions of a program letting the user display, from the terminal 1, one or more images corresponding to the thumbnails 11 of the photographic index 10. The customer's need is linked for example to the fact of being able to present rapidly to another person, from the terminal 1, digital images 22 in good viewing conditions. Said images 22 are presented on the screen 2 of the terminal 1, or said images, once retrieved on the terminal 1 are forwarded electronically, for example accompanied by a message, to the electronic address of this other person. The display can be operated from the moment when the customer first receives automatic notification on the terminal 1.

The automatic notification can be for example in SMS type message form (Short Message Service). The message tells the customer user of the terminal 1, that their photographs are available. The message includes for example a formulation of the type: “To view your photos, send an SMS to the 7777-77 giving the identifier number located at the top of the photo index.”

According to the main embodiment of the invention, the customer starts to issue an initial request, by composing, from the keyboard 3 of the portable terminal 1, an electronic message of SMS type, in which are composed one or more identifiers corresponding respectively to the one or more printed photographic indexes 10 containing at least one developed thumbnail 11, or corresponding to one or several photographic film strips, each one containing at least one thumbnail 11 (latent image). The customer then sends the composed message to a unique SMS telephone number. This telephone number is for example composed from the keyboard 3, or is retrieved directly in a memory of the terminal 1. Once composed, the message is for example automatically sent to the server 5 in order to be processed. The software of the invention process lets the server 5 automatically process the message sent by automatically selecting a set of digital images that correspond to the digitization of the thumbnails 11 of the photographic index 10, or to the digitization of the thumbnails 11 of the photographic strip. Once the selection is performed, the set of selected digital images is made available to be transmitted to the terminal 1 that made the request. Notification of the availability of the digital images saved for example in the image database of the server 6, is automatically transmitted to the terminal 1, for example as a simple electronic message written on the screen 2. In a preferred embodiment, the notification includes for example a universal resource address or WAP URL (Uniform Resource Locator). According to FIG. 1, the URL enables the automatic retrieval of the digital images in the image database of the server 6 for example. This address provides a link that enables a display request on the terminal 1 to be validated. A simple activating click on this link operates the display request leading to the automatic transmission and display on the screen 2 of the terminal 1 having made the initial request, of a first digital image 22 included in the set of selected images.

In a specific embodiment of the invention, the provision (display) of the digital images 22 on the screen 2 of the terminal 1, is subordinated to an automatic invoicing of the customer, simultaneously carried out with the sending of the electronic message of SMS type comprising one (several) identifier(s) of photographic support(s) 10. The invention process uses for example an invoicing mode of SMS type or of additional charge SMS type (Premium type). The use of these types of invoicing mode enables to adapt the value of the invoiced sum, in function of different parameters inherent to the content of the electronic message. These parameters take for example in account the number of images 22 to be displayed (12, 24, 36, etc.), current special offers, or other specific parameters.

In general when the photographic index 10 comprises a plurality of thumbnails 11, the transmission of the plurality of corresponding digital images 22 to the terminal 1 is operated according to an embodiment that enables automatic successive display of these digital images 22 on the screen 2 in a display sequence whose frequency can be programmed. Each image 22 stays displayed for example for 10 seconds. This frequency can be modified from the terminal 1. In another embodiment, a first digital image 22 belonging to the set of selected digital images is automatically displayed on the display screen 2 of the terminal 1, and each of the other images belonging to said set is then displayed on the screen 2 from a manual request, (for example: simple click) performed from the keyboard 3 of the terminal 1.

According to an alternative to the main embodiment, the invention process enables, from the display on the screen 2 of all the identifiers 12 specific to the thumbnails 11 of a photographic support 10, for example a photographic index, the selection of at least one identifier 12 of said set; the method also enables the validation of the selection of the identifier 12 thus performed, so as to then display on the screen 2 of the terminal 1, the digital images 22 corresponding to the selected identifier 12. The customer can thus select, from the thumbnails 11 of the photographic index 10, only the digital images 22 that they wish to receive and display on the terminal 1.

While the invention has been described with reference to the preferred embodiments, it is clear that this application covers all modifications or variants that correspond with the purpose of the invention and can be implemented by the invention process. Accordingly, such embodiments are for illustration and do not restrict the claimed protection.

1. A process enabling a digital image to be displayed on a terminal equipped with a keyboard and a display screen, the process comprising the steps of:
a) composing from the keyboard of the terminal, an electronic message including at least one identifier of a photographic support comprising thumbnails;
b) sending from the terminal, the electronic message composed in said step a) to a messaging server, said messaging server being identified by a unique telephone number;
c) automatically transmitting said electronic message to a processing server;
d) automatically processing, from the processing server, the electronic message sent, in order to select a set of digital images corresponding to the thumbnails of the identified photographic support and included in the electronic message;
e) automatically transmitting to the terminal a notification of the availability of the set of selected digital images;
f) automatically displaying on the screen of the terminal the notification of the availability of the selected digital images;
g) validating, from the terminal, a display request for the available digital images;
h) automatically transmitting the available digital images to the terminal; and
i) automatically displaying said digital images on the screen of the terminal.

2. The process according to claim 1, wherein, during said step b) an automatic invoicing is further carried out, the value of the invoiced sum being a function of a content of the electronic message composed at said step a).

3. The process of claim 1, wherein the display request comprises activating, from the keyboard of the terminal, a universal resource location (URL) mentioned in the notification of availability.

4. The process of claim 1, wherein from the display on the screen of all the identifiers specific to the thumbnails of a photographic support, it enables the selection of at least one identifier of said set, and in that it enables the validation of the identifier selection performed, so as to display on the screen of the terminal, the digital image corresponding to the selected identifier.

5. The process of claim 1, such that in the transmission of a plurality of digital images to the terminal, said digital images are automatically displayed successively in a display sequence whose frequency can be programmed.

6. The process of claim 1, such that in the transmission of a plurality of digital images to the terminal, said digital images are displayed successively according to a request manually performed from the keyboard of the terminal.

7. The process of claim 1, wherein the photographic support comprises an identifier located in a zone of said photographic support.

8. The process of claim 1, wherein the photographic support is a photographic index comprised of photographic paper.

9. The process of claim 1, wherein the photographic support is a photographic film strip.

10. The process of claim 1, wherein the identifier of the photographic support is placed on a material support distinct from said photographic support.

11. The process of claim 1, wherein the terminal is a portable terminal.

12. The process of claim 11, wherein the portable terminal is a cell phone.
